(19) United States
(12) Patent Application Publication
(10) Pub. No.: US 2018/0162100 A1
(43) Pub. Date: Jun. 14, 2018

(54) ADHESIVE FOR LAMINATING METAL FOIL AND RESIN FILM, LAMINATED BODY, PACKAGING MATERIAL FOR BATTERY EXTERIOR, AND BATTERY CASE AND METHOD FOR MANUFACTURING SAME

(71) Applicant: SHOWA DENKO K.K., Tokyo (JP)

(72) Inventors: Kazunari FUKASE, Himeji-shi, Hyogo (JP); Hiroto KOUKA, Tatsuno-shi, Hyogo (JP); Yasuhiro NAKAGAWA, Kakogawa-shi, Hyogo (JP); Mitsuru DOI, Tatsuno-shi, Hyogo (JP)

(73) Assignee: SHOWA DENKO K.K., Tokyo (JP)

(21) Appl. No.: 15/576,337

(22) PCT Filed: May 17, 2016
(86) PCT No.: PCT/JP2016/064655

§ 371 Date: Nov. 22, 2017

(30) Foreign Application Priority Data
Jun. 10, 2015 (JP) 2015-117745
Sep. 2, 2015 (JP) 2015-172912

(51) Int. Cl. B32B 15/095; H01M 2/02; B32B 7/12; C08G 18/79; C09J 175/04

(52) U.S. Cl. CPC B32B 15/095; H01M 2/0257; C09J 175/04; C08G 18/79; B32B 7/12

(57) ABSTRACT

An adhesive for laminating a metal foil to a resin film, the adhesive including: a polyol (A); a multimer of a polyisocyanate (B); and a metal compound (C) being a compound of at least one metal of Groups 7 and 12, wherein the multimer of a polyisocyanate (B) includes a multimer of a saturated aliphatic polyisocyanate (b1) and a multimer of a saturated alicyclic polyisocyanate (b2).

### TECHNICAL FIELD

The present invention relates to an adhesive for laminating a metal foil to a resin film suitable as an adhesive for a covering material of a secondary battery such as a lithium ion battery, a laminate produced by using the adhesive for laminating a metal foil to a resin film, a packaging material for a battery casing using the laminate, and a battery case formed of the packaging material for a battery casing and a method for producing the battery case.

### BACKGROUND ART

In recent years, the reduction in size, weight, and thickness of electronic appliances such as notebook personal computers and mobile phones has proceeded. Therefore, higher energy density and reduction in weight are required also for secondary batteries for electronic appliances, and development of lithium ion batteries having high energy density has been actively made instead of conventional lead storage batteries and nickel hydride batteries. Further, a lithium ion battery which can be used also as a power source of an electric vehicle or a hybrid car has been put in practical use.

In the lithium ion battery, a compound containing lithium is used as a positive electrode material, and a carbon material such as graphite and coke is used as a negative electrode material. Further, between a positive electrode and a negative electrode, there is provided an electrolytic solution in which a lithium salt such as LiPF₆ and LiBF₄ as an electrolyte is dissolved in an aprotic solvent having osmotic force such as ethylene carbonate, propylene carbonate and diethyl carbonate or an electrolyte layer comprising a polymer gel impregnated with the electrolytic solution.

Conventionally, as a packaging material for a battery case, there has been known a laminate in which a stretched heat resistant resin film layer as an outer layer, an aluminum foil layer, and a non-stretched thermoplastic resin film layer as an inner layer are laminated in this order. In the case of a battery case obtained by using a packaging material for battery cases having such a structure, if a solvent having osmotic force like an electrolytic solution passes through a film layer serving as a sealant in a laminate used for the outer packaging of the battery, the laminate strength between an aluminum foil layer and a resin film layer may be reduced to cause the leakage of the electrolytic solution. Therefore, there has been developed a packaging material for battery cases in which an aluminum foil layer and an inner layer are bonded through an adhesive layer containing a resin containing a functional group having reactivity with isocyanates such as an acid anhydride group, a carboxyl group, and a hydroxy group, and a polyfunctional isocyanate compound.

For example, Patent Literature 1 describes a method involving forming an adhesive layer using a solvent type adhesive in which a modified polyolefin resin obtained by graft-polymerizing an ethylenically unsaturated carboxylic acid or an anhydride thereof onto a propylene homopolymer or a copolymer of propylene and ethylene, and a polyfunctional isocyanate compound, are dissolved or dispersed in an organic solvent.

However, the modified polyolefin resin in Patent Literature 1 shows a change with time in long-term storage and after being dissolved in a solvent. Therefore, the operability of the modified polyolefin resin may often be unstable on coating, and the adhesive strength of the adhesive layer formed may show variation. Further, there was a problem that an adhesive strength at high temperatures assuming an on-vehicle applications or the like was poor.

Meanwhile, Patent Literature 2 describes an adhesive composition in which a polyolefin polyol and a polyfunctional isocyanate curing agent are used as essential components, and a thermoplastic elastomer and/or a tackifier are further added thereto; and Patent Literature 3 describes an adhesive composition containing one or more main agents selected from the group consisting of a polyester polyol having a hydrophobic unit derived from a dimer fatty acid or a hydrogenated product thereof and an isocyanate-extended product of the polyester polyol, and a curing agent comprising one or more polyisocyanate compounds selected from the group consisting of crude tolylene diisocyanate, crude diphenylmethane diisocyanate, and polymeric diphenylmethane diisocyanate.

### CITATION LIST

### Patent Literature

PTL1: JP 2010-92703 A
PTL2: JP 2005-63685 A
PTL3: JP 2011-187385 A

### SUMMARY OF INVENTION

### Technical Problem

In the case of Patent Literature 2 and Patent Literature 3, when an adhesive layer contacts the electrolytic solution which penetrates through a film layer serving as a sealant in the laminate during long-term use, the adhesive strength may be reduced to reduce the quality of a battery. Particularly, when the adhesive layer contacts the electrolytic solution for a long term, the adhesive strength will be significantly reduced to enhance the risk of electrolytic solution leakage, which is problematic.

The present invention has been completed taking the background art as described above into consideration, and an object of the present invention is to provide an adhesive for laminating a laminating metal foil to a resin film, the adhesive having excellent adhesive strength and being excellent in heat resistance and electrolytic solution resistance in a well-balanced manner. Further, another object of the present invention is to provide a laminate of a metal foil and a resin film, the laminate being excellent in heat resistance and electrolytic solution resistance in a well-balanced manner and being suitable as a packaging material for a battery casing. Furthermore, a still another object of the present invention is to provide a battery case being excellent in heat resistance and electrolytic solution resistance in a well-balanced manner, the battery case being formed of the packaging material for a battery casing comprising the laminate, and a method for producing the battery case.

### Solution to Problem

Specifically, the present invention relates to the following [1] to [15].

[1] An adhesive for laminating a metal foil to a resin film, the adhesive comprising: a polyol (A); a multimer of a polyisocyanate (B); and a metal compound (C) being a compound of at least one metal of Groups 7 and 12, wherein the multimer of a polyisocyanate (B) comprises a multimer of a saturated aliphatic polyisocyanate (b1) and a multimer of a saturated alicyclic polyisocyanate (b2).

[2] The adhesive for laminating a metal foil to a resin film according to [1], wherein the polyol (A) comprises a polyurethane polyol obtained by polyaddition of components comprising at least one of a chain polyolefin polyol (a11) and a polyester polyol (a12), a hydroxylated cyclic hydrocarbon compound (a2) having both a saturated cyclic hydrocarbon structure and two or more hydroxy groups, and a polyisocyanate (a3).

[3] The adhesive for laminating a metal foil to a resin film according to [2], wherein the polyester polyol (a12) comprises a polyester polyol having a constituent unit derived from a hydrogenated dimer acid and a constituent unit derived from a hydrogenated dimer diol.

[4] The adhesive for laminating a metal foil to a resin film according to any one of [1] to [3], wherein the multimer of a saturated aliphatic polyisocyanate (b1) comprises an isocyanurate form of a saturated aliphatic polyisocyanate.

[5] The adhesive for laminating a metal foil to a resin film according to any one of [1] to [4], wherein the multimer of a saturated alicyclic polyisocyanate (b2) comprises a multimer of isophorone diisocyanate.

[6] The adhesive for laminating a metal foil to a resin film according to any one of [1] to [5], wherein the ratio of the number of isocyanato groups contained in the multimer of a saturated aliphatic polyisocyanate (b1) and the multimer of a saturated alicyclic polyisocyanate (b2) to the number of hydroxy groups contained in the polyol (A) is 1 to 15.

[7] The adhesive for laminating a metal foil to a resin film according to any one of [1] to [6], wherein the metal compound (C) comprises at least one or more carboxylate of at least one metal of Groups 7 and 12.

[8] The adhesive for laminating a metal foil to a resin film according to any one of [1] to [7], wherein the metal compound (C) comprises a carboxylate of zinc or manganese.

[9] The adhesive for laminating a metal foil to a resin film according to any one of [1] to [8], the adhesive further comprising a solvent (D).

[10] A laminate in which a metal foil and a resin film are laminated through an adhesive layer obtained from the adhesive for laminating a metal foil to a resin film according to any one of [1] to [9].

[11] The laminate according to [10], wherein the metal foil is aluminum foil, and the resin film comprises a heat-fusible resin film.

[12] The laminate according to [10] or [11], wherein the thickness of the metal foil is 10 to 100 μm, and the thickness of the resin film is 9 to 100 μm.

[13] A packaging material for a battery casing obtained by using the laminate according to any one of [10] to [12].

[14] A battery case obtained by using the packaging material for a battery casing according to [13].

[15] A method for producing a battery case, comprising: deep drawing or stretch forming the packaging material for a battery casing according to [13].

[16] The adhesive for laminating a metal foil to a resin film according to any one of [2] to [9], wherein the chain polyolefin polyol (a11) comprises at least one of a polybutadiene polyol and a hydrogenated polybutadiene polyol, is preferably at least one of a polybutadiene polyol and a hydrogenated polybutadiene polyol, more preferably comprises a hydrogenated polybutadiene polyol, and still more preferably is a hydrogenated polybutadiene polyol.

[17] The adhesive for laminating a metal foil to a resin film according to any one of [2] to [9], and [16], wherein the hydroxylated cyclic hydrocarbon (a2) has a saturated alicyclic structure having a crosslinked structure, preferably a norbornane skeleton, an adamantane skeleton or a tricyclodecane skeleton, and more preferably a tricyclodecane skeleton.

[18] The adhesive for laminating a metal foil to a resin film according to any one of [2] to [9], and [16] and [17], wherein the polyisocyanate (a3) is a saturated aliphatic diisocyanate, preferably 1,4-cyclohexane diisocyanate, isophorone diisocyanate, methylene bis(4-cyclohexylisocyanate), 1,3-bis(isocyanatomethyl)cyclohexane, 1,4-bis(isocyanatomethyl)cyclohexane or norbornane diisocyanate, and more preferably methylene bis(4-cyclohexylisocyanate).

[19] The adhesive for laminating a metal foil to a resin film according to any one of [1] to [9], and [16] to [18], wherein the multimer of a saturated alicyclic polyisocyanate (b2) is at least one of an allophanatized multimer and an isocyanurate form of isophorone diisocyanate and preferably an allophanatized multimer of isophorone diisocyanate.

### Advantageous Effects of Invention

The adhesive for laminating a metal foil to a resin film of the present invention is excellent in adhesive strength, and a laminate of a metal foil and a resin film which is formed by using the adhesive for laminating a metal foil to a resin film is excellent in heat resistance and electrolytic solution resistance in a well-balanced manner. Therefore, the laminate is suitable as a material for a packaging material for a battery casing used for preparing a secondary battery such as a lithium ion battery. Further, a battery case formed by using the packaging material for a battery casing of the present invention is excellent in heat resistance and electrolytic solution resistance in a well-balanced manner, and its use can provide a safe secondary battery having a long life.

### DESCRIPTION OF EMBODIMENTS

### [Adhesive for Laminating Metal Foil to Resin Film]

The adhesive for laminating a metal foil to a resin film according to the present embodiment comprises a polyol (A), a multimer of a polyisocyanate (B), and a metal compound (C) being a compound of at least one metal of Groups 7 and 12, wherein the multimer of a polyisocyanate (B) comprises a multimer of a saturated aliphatic polyisocyanate (b1) and a multimer of a saturated alicyclic polyisocyanate (b2).

In the adhesive for laminating a metal foil to a resin film according to the embodiment of the present invention, the polyol (A) corresponds to a main agent, and the multimer of a polyisocyanate (B) corresponds to a curing agent and the metal compound (C) corresponds to a reaction accelerator.

The adhesive for laminating a metal foil to a resin film according to the embodiment of the present invention can be suitably used for the adhesion of a metal foil to a resin film.

Particularly, it is useful as an adhesive for laminating a metal foil to a resin film, and a laminate therewith can be suitably used as a packaging material for a battery casing.

The symbol “-” used herein means a value before the “-” or more and a value after the “-” or less.

### <Polyol (A)>

The polyol (A) used in the embodiment of the present invention (hereinafter may be referred to as “component (A)” or “(A)”) is not particularly limited, as long as it contains two or more hydroxy groups in its molecular structure. From the point of view of electrolytic solution resistance, the polyol (A) preferably comprises a polyurethane polyol (A1) obtained by polyaddition of components comprising at least one compound selected from the group consisting of three compounds of a chain polyolefin polyol (a11), a polyester polyol (a12) and a hydroxylated cyclic hydrocarbon compound (a2) having both a saturated cyclic hydrocarbon structure and two or more hydroxy groups, and a polyisocyanate (a3).

From the similar point of view, the polyol (A) more preferably comprises a polyurethane polyol (A2) obtained by polyaddition of components comprising at least one of a chain polyolefin polyol (a11) and a polyester polyol (a12), and a polyisocyanate (a3).

From the similar point of view, the polyol (A) still more preferably comprises a polyurethane polyol (A3) obtained by polyaddition of components comprising at least one of a chain polyolefin polyol (a11) and a polyester polyol (a12), a hydroxylated cyclic hydrocarbon compound (a2) having both a saturated cyclic hydrocarbon structure and two or more hydroxy groups, and a polyisocyanate (a3).

The above-mentioned polyol (A), polyurethane polyol (A1), polyurethane polyol (A2) and polyurethane polyol (A3) preferably comprises at least one of a chain polyolefin polyol (a11) and a polyester polyol (a12) as the component which from they are derived, and from the point of view of electrolytic solution resistance, more preferably comprises a chain polyolefin polyol (a11).

The polyol (A) may comprise any polyol other than the above-mentioned polyurethane polyols (A1), (A2) and (A3), as long as it does not impair the effect of the embodiment of the present invention, but from the point of view of electrolytic solution resistance, preferably does not comprise it.

When the polyol (A) comprise a polyurethane polyol (A1), the content of the polyurethane polyol (A1) in the polyol (A) is preferably 80% by mass or more, more preferably 90% by mass or more, still more preferably 95% by mass or more, and further still more preferably 100% by mass.

When the polyol (A) comprise a polyurethane polyol (A2), the content of the polyurethane polyol (A2) in the polyol (A) is preferably 80% by mass or more, more preferably 90% by mass or more, still more preferably 95% by mass or more, and further still more preferably 100% by mass.

When the polyol (A) comprise a polyurethane polyol (A3), the content of the polyurethane polyol (A3) in the polyol (A) is preferably 80% by mass or more, more preferably 90% by mass or more, still more preferably 95% by mass or more, and further still more preferably 100% by mass.

The total content of the component (a11), the component (a12), the component (a2) and the component (a3) in the polyol (A) is preferably 80% by mass or more, more preferably 90% by mass or more, still more preferably 95% by mass or more, and further still more preferably 100% by mass.

[Chain Polyolefin Polyol (a11)]

The chain polyolefin polyol (a11) in the embodiment of the present invention means a polyolefin polyol containing no alicyclic structure.

The chain polyolefin polyol (a11) used in the embodiment of the present invention (hereinafter also referred to as “polyolefin polyol (a11)” or “component (a11)” or “(a11)”) is not particularly limited, as long as it contains a polyolefin skeleton prepared by polymerizing or copolymerizing one or two or more olefins and two or more hydroxy groups and has no alicyclic structure in its molecular structure.

The chain polyolefin polyol (a11) may be a hydrogenated one (hydrogenated product) or a non-hydrogenated one (non-hydrogenated product), but from the point of view of electrolytic solution resistance, a hydrogenated one (hydrogenation product) is preferred.

Specific examples of the chain polyolefin polyol (a11) include polydiene polyols such as polybutadiene polyol and polyisoprene polyol, graft polymers of polydiene polyols and polyolefins, and hydrogenated products of these polydiene polyols and graft polymers. These may be used singly or in combination of two or more.

Examples of commercially available products thereof include G-1000, G-3000, GI-1000, GI-3000 (all manufactured by Nippon Soda Co., Ltd.) and Epaule (manufactured by Idemitsu Kosan Co., Ltd.).

[Polyester Polyol (a12)]

The polyester polyol (a12) in the embodiment of the present invention (hereinafter also referred to “component (a12)” or “(a12)”) is not particularly limited, as long as it contains an ester bond and two or more hydroxy groups in its molecular structure.

Further, from the point of view of electrolytic solution resistance, the polyester polyol (a12) is preferably at least one of a polyester polyol having a constituent unit derived from a hydrogenated dimer acid and a constituent unit derived from a hydrogenated dimer diol, and castor oil; more preferably comprises a polyester polyol having a constituent unit derived from a hydrogenated dimer acid and a constituent unit derived from a hydrogenated dimer diol; and is still more preferably a polyester polyol having a constituent unit derived from a hydrogenated dimer acid and a constituent unit derived from a hydrogenated dimer diol.

The “dimer acid” in the embodiment of the present invention refers to a dimer acid (dimeric acid) obtained by allowing fatty acids having an ethylenic double bond (hereinafter also referred to as “unsaturated fatty acid A”) to react with each other at the double bond site.

The unsaturated fatty acid A preferably has 14 to 22 carbon atoms. It is considered that such a relatively long hydrocarbon chain enhances the electrolytic solution resistance.

The dimer acid is preferably a dimer acid obtained by allowing an unsaturated fatty acid A having 2 to 4 ethylenic double bonds to react with an unsaturated fatty acid A having 1 to 4 ethylenic double bonds, more preferably a dimer acid obtained by allowing an unsaturated fatty acid A having two ethylenic double bonds to react with an unsaturated fatty acid A having one or two ethylenic double bonds. The two unsaturated fatty acids A from which these dimer acids are derived may be different or the same.

Examples of the above unsaturated fatty acid A include tetradecenoic acid (tsuzuic acid, physeteric acid, and myristoleic acid), hexadecenoic acid (such as palmitoleic acid), octadecenoic acid (such as oleic acid, elaidic acid, and vaccenic acid), eicosenic acid (such as gadoleic acid), dococenoic acid (such as erucic acid, cetoleic acid, and brassidic acid), tetradecadienoic acid, hexadecadienoic acid, octadecadienoic acid (such as linoleic acid), eicosadienoic acid, docosadienoic acid, octadecatrienoic acid (such as linolenic acid), and eicosatetraenoic acid (such as arachidonic acid); and oleic acid or linoleic acid is most preferred. The resulting dimer acid is a mixture of dimer acids whose structures are generally different due to the position of a double bond or isomerization. The dimer acids in the mixture may be separated and used, or the mixture may be used as it is. Further, the resulting dimer acid may contain a small amount of monomer acid (for example, 6% by mass or less, particularly 4% by mass or less) and/or polymeric acid including trimer and higher acid (for example, 6% by mass or less, particularly 4% by mass or less).

The “hydrogenated dimer acid” in the embodiment of the present invention refers to a saturated dicarboxylic acid obtained by hydrogenating a carbon-carbon double bond of the dimer acid. Examples of commercially available products of the hydrogenated dimer acid include EMPOL 1008 and EMPOL 1062 (both manufactured by BASF AG) and PRIPOL 1009 (manufactured by Croda, Inc.).

The “hydrogenated dimer diol” in the embodiment of the present invention contains a diol as a main component, and the diol is prepared as follows: at least one of the dimer acid, the hydrogenated dimer acid, and a lower alcohol ester thereof is reduced in the presence of a catalyst to convert a carboxylic acid part or a carboxylate part of the dimer acid into an alcohol and, when the raw material has a carbon-carbon double bond, the double bond is hydrogenated. Examples of commercially available products of the hydrogenated dimer diol include Sovermol 1908 (manufactured by BASF AG) and PRIPOL 2033 (manufactured by Croda, Inc.).

The polyester polyol (a12) used in the embodiment of the present invention can be produced by the condensation reaction (dehydration esterification reaction), in the presence of an esterification catalyst such as butyltin dilaurate, of an acid component comprising the hydrogenated dimer acid as an essential component and an alcohol component comprising the hydrogenated dimer diol as an essential component. Alternatively, the polyester polyol (a12) used in the present invention can also be produced by the transesterification reaction, in the presence of a transesterification catalyst, of an ester component comprising the lower alkyl ester of the hydrogenated dimer acid as an essential component and an alcohol component comprising the hydrogenated dimer diol as an essential component.

### [Hydroxylated Cyclic Hydrocarbon Compound (a2) Having Saturated Cyclic Hydrocarbon Structure and Two or More Hydroxy Groups]

The hydroxylated cyclic hydrocarbon compound (a2) having both a saturated cyclic hydrocarbon structure and two or more hydroxy groups used in the embodiment of the present invention (hereinafter also referred to as “hydroxylated cyclic hydrocarbon (a2)” or “component (a2)” or “(a2)”) is not particularly limited, as long as it is any compound that has a saturated alicyclic hydrocarbon structure, two or more hydroxy groups, and a structure of other parts comprising a hydrocarbon, in view of the electrolytic solution resistance of the adhesive layer obtained from the adhesive for laminating a metal foil to a resin film according to the embodiment of the present invention.

Examples of the saturated cyclic hydrocarbon structure include cycloalkane skeletons, such as a cyclopentane skeleton, a cyclohexane skeleton, and a cycloheptane skeleton, and saturated alicyclic structures each having a crosslinked structure such as a norbornane skeleton, an adamantane skeleton, and a tricyclodecane skeleton; and examples of the hydroxylated cyclic hydrocarbons (a2) each having such a structure include cyclopentanediol, cyclohexanediol, cyclohexanedimethanol, norbornanediol, adamantanediol, tricyclodecanedimethanol, and adamantanetriol. These may be used singly or in combination of two or more. Those containing a saturated alicyclic structure having a crosslinked structure are preferred, and preferred examples thereof include norbornanediol, adamantanediol, tricyclodecanedimethanol, and adamantanetriol. Examples of commercially available products thereof include adamantanetriol (manufactured by Idemitsu Kosan Co., Ltd., manufactured by Mitsubishi Gas Chemical Co., Inc.) and TCD Alcohol DM (manufactured by OXEA GmbH).

[Polyisocyanate (a3)]

The polyisocyanate (a3) used in the embodiment of the present invention (hereinafter also referred to as “component (a3)” or “(a3)”) is not particularly limited as long as it is a compound containing two or more isocyanato groups or a multimer thereof. Examples of the polyisocyanate (a3) include saturated alicyclic diisocyanates such as 1,4-cyclohexane diisocyanate, isophorone diisocyanate, methylenebis(4-cyclohexyl isocyanate), 1,3-bis(isocyanatomethyl)cyclohexane, 1,4-bis(isocyanatomethyl)cyclohexane, and norbornane diisocyanate, aromatic diisocyanates such as 2,4-tolylene diisocyanate, 2,6-tolylene diisocyanate, diphenylmethane-4,4′-diisocyanate, 1,3-xylylene diisocyanate, and 1,4-xylylene diisocyanate, and aliphatic diisocyanates such as hexamethylene diisocyanate, 2,4,4-trimethylhexamethylene diisocyanate, and 2,2,4-trimethylhexanemethylene diisocyanate, and allophanatized multimers, isocyanurate form, and biuret-modified products thereof. These may be used singly or in combination of two or more. Preferred are saturated alicyclic diisocyanates including 1,4-cyclohexane diisocyanate, isophorone diisocyanate, methylenebis(4-cyclohexyl isocyanate), 1,3-bis(isocyanatomethyl)cyclohexane, 1,4-bis(isocyanatomethyl)cyclohexane, and norbornane diisocyanate; and particularly preferred are isophorone diisocyanate (3-isocyanatomethyl-3,5,5-trimethylcyclohexyl isocyanate) and methylenebis(4-cyclohexyl isocyanate) (another name: dicyclohexylmethane-4,4′-diisocyanate). Examples of commercially available products thereof include Desmodur I, Desmodur W (both manufactured by Beyer AG), IPDI, and H12MDI (both manufactured by Degussa AG).

### [Method for Producing Polyurethane Polyol]

The method for producing the polyurethane polyol used in the embodiment of the present invention can be, for example, be performed by polyaddition reaction of a polyolefin polyol (a11) and/or a polyester polyol (a12), and a polyisocyanate (a3), and if desired a hydroxylated cyclic hydrocarbon compound (a2) in the presence or absence of a known urethanation catalyst such as dibutyltin dilaurate, dioctyltin dilaurate, bismuth tris(2-ethylhexanoate) and zirconium tetraacetylacetonate. The reaction may be preferably performed in the presence of a catalyst to reduce the reaction time. The amount of the catalyst added is preferably 0.001 to 1.00 part by mass, more preferably 0.005 to 0.50 part by mass, and still more preferably 0.01 to 0.30 part by mass, based on 100 parts by mass of the total amount of the components (a11), (a12), (a2), and (a3). When the amount is 0.001 part by mass or more, the reaction proceeds sufficiently fast; and when the amount is 1 part by mass or less, the adhesive strength can be retained.

In the polyaddition reaction, all of the polyolefin polyol (a11) and/or the polyester polyol (a12), the hydroxylated cyclic hydrocarbon compound (a2), and the polyisocyanate (a3) may be allowed to react with each other at one time. Alternatively, the polyolefin polyol (a11) and/or the polyester polyol (a12) and the hydroxylated cyclic hydrocarbon compound (a2) may be, each separately or in a suitable combination, allowed to react with the polyisocyanate (a3), followed by mixing and further allowing all the components to react with each other. Specifically, in the latter method, for example, the hydroxylated cyclic hydrocarbon compound (a2) is allowed to react with the polyisocyanate (a3) to obtain a polyurethane polyisocyanate, and then the polyolefin polyol (a11) and/or the polyester polyol (a12) is allowed to react with the polyurethane polyisocyanate to obtain the polyurethane polyol.

Further, the polyaddition reaction may be performed in a solvent. The solvent to be used is not limited. However, when the same solvent as the solvent (D) to be described below, which can be contained in the adhesive for laminating a metal foil to a resin film according to the embodiment of the present invention, is used, a step of solvent distillation or the like can be eliminated, and the adhesive can be produced at a lower cost and with a lower environmental burden.

The amount of the solvent added is preferably 50 to 500 parts by mass, more preferably 50 to 200 parts by mass, and still more preferably 80 to 120 parts by mass, based on 100 parts by mass of the total amount of the components (a11), (a12), (a2), and (a3).

Further, an antioxidant such as hydroquinone monomethyl ether may be added in this polyaddition reaction. The amount of the antioxidant added is preferably 0.001 to 1.00 part by mass, more preferably 0.005 to 0.50 part by mass, and still more preferably 0.01 to 0.35 part by mass, based on 100 parts by mass of the total amount of the components (a11), (a12), (a2), and (a3).

When the polyurethane polyol is produced, the ratio of the number of isocyanato groups contained in the polyisocyanate (a3) to the number of hydroxy groups contained in the components (a11), (a12), and (a2) (hereinafter also referred to as “NCO/OH ratio”) is preferably 0.5 to 1.1, more preferably 0.7 to 1.05, and further preferably 0.8 to 1.0. When the NCO/OH ratio is 0.5 or more, the adhesive strength of the adhesive layer obtained from the adhesive for laminating a metal foil to a resin film according to the embodiment of the present invention will be hardly reduced even if the adhesive layer contacts an electrolytic solution; and when the NCO/OH ratio is 1.1 or less, the gelation in the production of the polyurethane polyol will not easily occur, and the operability of the adhesive for laminating a metal foil to a resin film according to the embodiment of the present invention on coating will be satisfactory.

Note that the number of hydroxy groups contained in each polyol component can be determined by the method A of JIS K 1557-1:2007 (titration method). The number of isocyanato groups contained in each isocyanate component can be determined by JIS K 6806:2003 (titration method).

Although component (a2) does not need to be contained, preferably it is contained. When component (a2) is contained and the polyurethane polyol is produced, the amount of the component (a2) based on 100 parts by mass of the total amount of the components (a11) and (a12) is preferably 1 to 100 parts by mass, more preferably 5 to 50 parts by mass, and further preferably 5 to 20 parts by mass. When the amount is 1 part by mass or more, the adhesive strength of the adhesive layer obtained from the adhesive for laminating a metal foil to a resin film will be hardly reduced even if the adhesive layer contacts an electrolytic solution; and when the amount is 100 parts by mass or less, the solubility of the polyurethane polyol in a solvent and the operability of the adhesive for laminating a metal foil to a resin film on coating will be satisfactory.

### <Multimer of Polyisocyanate (B)>

The multimer of a polyisocyanate (B) in the embodiment of the present invention (hereinafter may be referred to as “component (B)” or “(B)”) is used as a curing agent in the adhesive for laminating a metal foil to a resin film according to the embodiment of the present invention.

Thus, the use of the polyisocyanate in the form of a multimer will make the adhesive for laminating a metal foil to a resin film to be excellent in heat resistance and electrolytic solution resistance. For unknown reasons, it is presumed that it is because the structures of the isocyanurate form and the allophanatized multimer and the like are excellent in heat resistance and electrolytic solution resistance.

The multimer of a polyisocyanate in the embodiment of the present invention (B) comprises both a multimer of a saturated aliphatic polyisocyanate (b1) and a multimer of a saturated alicyclic polyisocyanate (b2). When the multimer of a polyisocyanate in the embodiment of the present invention (B) comprises both a multimer of a saturated aliphatic polyisocyanate (b1) and a multimer of a saturated alicyclic polyisocyanate (b2), the adhesive strength in the case of the adhesive layer obtained from the adhesive for laminating a metal foil to a resin film contacting the electrolytic solution will be increased as compared to when it comprises the multimer of a saturated aliphatic polyisocyanate (b1) alone, whereas the adhesive strength at high temperatures will be increased as compared to when it comprises the multimer of a saturated alicyclic polyisocyanate (b2) alone.

For the multimer of a polyisocyanate in the embodiment of the present invention (B), note that at the time of preparing the adhesive for laminating a metal foil to a resin film, a multimer of a saturated aliphatic polyisocyanate (b1) and a multimer of a saturated alicyclic polyisocyanate (b2) may be mixed before charging them or may be charged separately.

The multimer of a saturated aliphatic polyisocyanate used in the embodiment of the present invention (b1) (hereinafter may be referred to as “component (b1)” or (b1)) is not particularly limited, as long as it is any multimer of a saturated aliphatic compound having two or more isocyanato groups. Examples of the multimer of a saturated aliphatic polyisocyanate include an allophanatized multimer, an isocyanurate form and a biuret-modified form of an aliphatic diisocyanate such as hexamethylene diisocyanate, 2,4,4-trimethyl hexamethylene diisocyanate, and 2,2,4-trimethyl hexamethylene diisocyanate. From the point of view of adhesive strength at high temperatures, the multimer of a saturated aliphatic polyisocyanate preferably comprises an isocyanurate form of a saturated aliphatic polyisocyanate, and more preferably is an isocyanurate form of a saturated aliphatic polyisocyanate.

The multimer of a saturated alicyclic polyisocyanate used in the embodiment of the present invention (b2) (hereinafter may be referred to as “component (b2)” or (b2)) is not particularly limited, as long as it is any multimer of a compound having two or more isocyanato groups and a saturated alicyclic structure. The multimer of a saturated alicyclic polyisocyanate preferably comprises a multimer of a saturated alicyclic diisocyanate such as 1,4-cyclohexane diisocyanate, isophorone diisocyanate, methylene bis(4-cyclohexylisocyanate), 1,3-bis(isocyanatomethyl)cyclohexane, 1,4-bis(isocyanatomethyl)cyclohexane and norbornane diisocyanate. Examples of the multimer include an allophanatized multimer, an isocyanurate form and a biuret-modified product. From the point of view of electrolytic solution resistance, an allophanatized multimer, an isocyanurate form or a biuret-modified form of isophorone diisocyanate are preferred.

The multimer of a polyisocyanate (B) may comprise any multimer of a polyisocyanate other than a multimer of a saturated aliphatic polyisocyanate (b1) and a multimer of a saturated alicyclic polyisocyanate (b2), but preferably does not comprise it.

The total amount of the multimer of a saturated aliphatic polyisocyanate (b1) and the multimer of a saturated alicyclic polyisocyanate (b2) in the multimer of a polyisocyanate (B) is preferably 80% by mass or more, more preferably 90% by mass or more, and still more preferably 95% by mass or more.

The mass ratio of the multimer of a saturated aliphatic polyisocyanate (b1) to the total amount of the multimer of a saturated aliphatic polyisocyanate (b1) and the multimer of a saturated alicyclic polyisocyanate (b2) [(b1)/((b1)+(b2))] is preferably 0.05 to 0.70, more preferably 0.10 to 0.60, still more preferably 0.20 to 0.50 and further still more preferably 0.30 to 0.40.

The ratio of the number of isocyanato groups contained in the multimer of a saturated aliphatic polyisocyanate (b1) and the multimer of a saturated alicyclic polyisocyanate (b2) to the number of hydroxy groups contained in the polyol (A) (NCO/OH ratio) is preferably 1 to 15, and more preferably 2 to 13. When the NCO/OH ratio is 1 or more, the adhesive strength of the adhesive layer obtained from the adhesive for laminating a metal foil to a resin film according to the embodiment of the present invention, particularly the adhesive strength of the adhesive layer to the resin film, will be satisfactory; and when the NCO/OH ratio is 15 or less, the adhesive strength of the adhesive layer obtained from the adhesive for laminating a metal foil to a resin film according to the embodiment of the present invention will be hardly reduced even if the adhesive layer contacts an electrolytic solution.

<Metal Compound (C) being a Compound of at Least One Metal of Groups 7 and 12>

The metal compound (C) being a compound of at least one metal of Groups 7 and 12 of the Periodic Table in the embodiment of the present invention (hereinafter also referred to as “metal compound(s) of Groups 7 and/or 12 (C)” or “metal compound (C)” or “component (C)” or “(C)”) is used as a reaction accelerator to accelerate the reaction of the polyurethane polyol (A) and the multimer of a polyisocyanate (B) in the adhesive for laminating a metal foil to a resin film according to the embodiment of the present invention.

The metal compound (C) being a compound of at least one metal of Groups 7 and 12 used in the embodiment of the present invention includes a compound of a metal element of Group 7 selected from the group consisting of manganese, technetium and rhenium and a compound of a metal element of Group 12 selected from the group consisting of zinc, cadmium and mercury, and these compounds can be used alone or in combination thereof.

Examples of the metal compound (C) being a compound of at least one metal of Groups 7 and 12 include a metal carboxylate such as a metal hexanoate, a metal octylate (2-ethylhexanoate), a metal neodecanoate, a metal stearate and a metal oleate, and a metal acetylacetonate. Among them, from the point of view of the adhesive strength after immersing in an electrolytic solution for a long period, the metal compound (C) preferably comprises a metal carboxylate, more preferably at least one or more of a carboxylate of a metal selected from the group consisting of manganese and zinc, and still more preferably a carboxylate of zinc.

Specifically, the metal compound (C) being a compound of at least one metal of Groups 7 and 12 is preferably zinc neodecanoate (C₂₀H₃₈O₄Zn), hexoate zinc (zinc octylate, zinc 2-ethylhexanoate, Cl₆H₃₀O₄Zn), zinc stearate (C₃₆H₇₀O₄Zn), zinc acetylacetonate (C₁₀H₁₄O₄Zn) or hexoate manganese (manganese octylate, manganese 2-ethylhexanoate, C₁₆H₃₀O₄Mn), and more preferably zinc neodecanoate (C₂₀H₃₈O₄Zn) or hexoate zinc (zinc octylate and zinc 2-ethylhexanoate, C₁₆H₃₀O₄Zn).

As a reaction accelerator other than the component (C), an organotin compound such as dibutyltin dilaurate, dioctyltin dilaurate and dioctyltin diacetate, or a tertiary amine such as 2,4,6-tris(dimethylaminomethyl)phenol, dimethyl aniline, dimethyl p-toluidine and N, N-di(3-hydroxyethyl)-p-toluidine may be used in combination with the component (C).

The ratio of the metal compound (C) being a compound of at least one metal of Groups 7 and 12 based on 100 parts by mass of the polyol (A) is not particularly limited, but the content of the metal compound (C) based on 100 parts by mass of the polyol (A) is preferably 0.0001 to 5 parts by mass, more preferably 0.001 to 3 parts by mass, still more preferably 0.01 to 1.5 parts by mass, and further still more preferably 0.03 to 1.5 parts by mass, in terms of the mass of the metal. When the content of the metal compound (C) is 0.0001 part by mass or more, the adhesive strength of the adhesive layer obtained from the adhesive for laminating a metal foil to a resin film of the present invention will sufficiently increase even after immersing in an electrolytic solution for a long period, and when the content of the metal compound (C) is 5 parts by mass or less, the adhesive strength in a normal state will increase. Note that the metal compound(s) of Groups 7 and 12 (C) may be added at the time of synthesizing the polyol (A) or may be added at the time of preparing the adhesive.

### <Solvent (D)>

The adhesive for laminating a metal foil to a resin film according to the embodiment of the present invention may also comprise a solvent (D) (hereinafter may be referred to as “component (D)” or “(D)”).

The solvent (D) is not particularly limited as long as it can dissolve or disperse the polyol (A), the multimer of a polyisocyanate (B) and the metal compound (C) being a compound of at least one metal of Groups 7 and 12. Examples of the solvent (C) include aromatic organic solvents such as toluene and xylene, alicyclic organic solvents such as cyclohexane, methylcyclohexane, and ethylcyclohexane, aliphatic organic solvents such as n-hexane and n-heptane, ester-based organic solvents such as ethyl acetate, propyl acetate, and butyl acetate, and ketone-based organic solvents such as acetone, methyl ethyl ketone, and methyl butyl ketone. These may be used singly or in combination of two or more.

Among these, especially in view of the solubility of the polyol (A), ethyl acetate, propyl acetate, butyl acetate, toluene, methylcyclohexane, and methyl ethyl ketone are preferred, and toluene is more preferred.

The content of the solvent (D) in the adhesive for laminating a metal foil to a resin film according to the embodiment of the present invention is preferably 30 to 80% by mass, more preferably 40 to 80% by mass, still more preferably 50 to 80% by mass, and further still more preferably 60 to 80% by mass. When the content of the solvent (D) is 30% by mass or more, the operability of the adhesive for laminating a metal foil to a resin film according to the embodiment of the present invention on coating will be satisfactory; and when the content of the solvent (D) is 80% by mass or less, the controllability of the thickness of the laminate obtained by coating and curing the adhesive for laminating a metal foil to a resin film according to the embodiment of the present invention will be satisfactory.

### <Other Components>

The adhesive for laminating a metal foil to a resin film of the embodiment of the present invention may optionally comprise additives such as a tackifier, and a plasticizer.

The tackifier is not particularly limited. Examples thereof include natural tackifiers such as a polyterpene resin and a rosin resin, and petroleum-based tackifiers such as an aliphatic (C5) resin, an aromatic (C9) resin, a copolymer (C5/C9) resin, and an alicyclic resin obtained from cracked petroleum fractions of naphtha. Further examples include a hydrogenated resin in which a double bond part of these resins is hydrogenated. These tackifiers may be used singly or in combination of two or more. Examples of the plasticizer include, but not particularly limited to, liquid rubbers such as polyisoprene and polybutene, and process oil.

Further, thermoplastic resins and thermoplastic elastomers, such as an acid-modified polyolefin resin, may be contained as long as they do not impair the effect of the embodiment of the present invention. Examples of the thermoplastic resins and the thermoplastic elastomers which can be contained include an ethylene-vinyl acetate copolymer resin, an ethylene-ethyl acrylate copolymer resin, SEBS (styrene-ethylene-butylene-styrene), and SEPS (styrene-ethylene-propylene-styrene).

The total content of components (A), (B), (C) and (D) in the adhesive for laminating a metal foil to a resin film according to the embodiment of the present invention is preferably 80% by mass or more, more preferably 90% by mass or more, and still more preferably 95% by mass or more.

### [Laminate]

The laminate according to the embodiment of the present invention is obtained by laminating a metal foil to a resin film through an adhesive layer obtained from the adhesive for laminating a metal foil to a resin film of the embodiment of the present invention (hereinafter may be simply referred to as the “laminating adhesive according to the embodiment of the present invention”).

Further, as long as the laminate according to the embodiment of the present invention contains a layer in which a metal foil is joined to a resin film through an adhesive layer obtained from the laminating adhesive according to the embodiment of the present invention, the laminate may contain other layers in which metal foils and/or resin films are joined to each other through the adhesive layer obtained from the laminating adhesive of the present invention. Known methods, such as a heat lamination method and a dry lamination method, can be used as the joining method. In the embodiment of the present invention, the heat lamination method comprises heat melting a laminating adhesive according to the embodiment of the present invention comprising no solvent (D) on the surface of a layer to be in contact with an adhesive layer or heat extruding the laminating adhesive together with the layer to be in contact with the adhesive layer, thereby inserting the laminating adhesive between the layers of a laminate to form the adhesive layer. Further, in the embodiment of the present invention, the dry lamination method comprises coating and drying a laminating adhesive according to the embodiment of the present invention comprising a solvent (D) on the surface of a layer to be in contact with an adhesive layer, stacking other layers thereon, and sticking them by compression, thereby inserting the laminating adhesive between the layers of a laminate to form the adhesive layer.

The applications of the laminate according to the embodiment of the present invention are not particularly limited, and examples of useful applications include packaging applications. Examples of the contents to be packaged with the laminate include a liquid material containing an acid, an alkali, an organic solvent, or the like, including a solvent-based material such as a putty (such as a putty for thick coating and a putty for thin coating), a coating material (such as oil paint), lacquer (such as clear lacquer), and a compound for motor vehicles. Further, since the laminate is suitable also for packaging the electrolytic solution of a lithium ion battery, it can be used as a packaging material for a battery casing, which is preferred. When the laminate is used as a packaging material for a battery casing, the metal foil is preferably aluminum foil; the resin film preferably comprises a heat-fusible resin film; and an outer layer comprising a heat resistant resin film is preferably provided outside the aluminum foil.

### [Packaging Material for Battery Casing]

The packaging material for a battery casing according to the embodiment of the present invention is formed by using the laminate according to the embodiment of the present invention.

The packaging material for a battery casing according to the embodiment of the present invention is preferably a packaging material in which an outer layer comprising a resin film, particularly a heat resistant resin film is provided outside the metal foil of the laminate according to the embodiment of the present invention. Further, in order to improve the characteristics such as mechanical strength and electrolytic solution resistance as needed, the packaging material may have a constitution in which a first intermediate resin layer or/and a second intermediate resin layer are added. In a preferred form, the packaging material may specifically have the following constitutions. Note that the adhesive layer means the “adhesive layer obtained from the laminating adhesive according to the embodiment of the present invention”, and the metal foil layer is illustrated as the aluminum foil layer.

(1) Outer layer/aluminum foil layer/adhesive layer/resin film layer
(2) Outer layer/first intermediate resin layer/aluminum foil layer/adhesive layer/resin film layer
(3) Outer layer/aluminum foil layer/second intermediate resin layer/adhesive layer/resin film layer
(4) Outer layer/first intermediate resin layer/aluminum foil layer/second intermediate resin layer/adhesive layer/resin film layer
(5) Coating layer/outer layer/aluminum foil layer/adhesive layer/resin film layer
(6) Coating layer/outer layer/first intermediate resin layer/aluminum foil layer/adhesive layer/resin film layer
(7) Coating layer/outer layer/aluminum foil layer/second intermediate resin layer/adhesive layer/resin film layer
(8) Coating layer/outer layer/first intermediate resin layer/aluminum foil layer/second intermediate resin layer/adhesive layer/resin film layer

### (First Intermediate Resin Layer and Second Intermediate Resin Layer)

In the above constitutions, a polyamide resin, a polyester resin, a polyethylene resin, or the like is used as the first intermediate resin layer, for the purpose of improving the mechanical strength of a packaging material for a battery casing. A heat adhesive extruded resin, such as a polyamide resin, a polyester resin, a polyethylene resin, and polypropylene, is used as the second intermediate resin layer similar to the first intermediate resin layer, mainly for the purpose of improving electrolytic solution resistance. A single-layer resin film and a multi-layer resin film (produced by two-layer co-extrusion, three-layer co-extrusion, or the like) can be used as the resin film layer. Further, the single-layer resin film and the multi-layer co-extruded resin film can also be used as the second intermediate resin layer. The thickness of the first intermediate resin layer and the second intermediate resin layer is, but not particularly limited to, normally about 0.1 to 30 m when these layers are provided.

### (Outer Layer)

The resin film used for the outer layer needs to be excellent in heat resistance, formability, insulation properties, and the like, and a stretched film of a polyamide (nylon) resin or a polyester resin is generally used. The thickness of the outer layer film is about 9 to 50 μm. When the thickness is less than 9 μm, the elongation of the stretched film will be poor when a packaging material is formed, which may lead to the occurrence of necking in the aluminum foil to easily result in poor forming. On the other hand, when the thickness is more than 50 μm, the effect of formability is not necessarily improved, and conversely, the volume energy density is reduced, leading only to cost increase. The thickness of the outer layer film is more preferably about 10 to 40 μm, further preferably 20 to 30 μm.

It is preferred to use the following film as a resin film used for the outer layer, in terms of obtaining a sharper shape: the film has a tensile strength of 150 N/mm² or more, preferably 200 N/mm² or more, and further preferably 250 N/mm² or more and a tensile elongation in three directions of 80% or more, preferably 100% or more, and further preferably 120% or more, when the film is cut to a predetermined size so that each of the three directions of 0°, 45°, and 90° may be the direction of tensileness and then subjected to a tensile test, where the direction of stretch of the stretched film is 0°. The above effect is sufficiently exhibited when the film has a tensile strength of 150 N/mm² or more or has a tensile elongation of 80% or more. Note that the values of the tensile strength and the tensile elongation are values at break in the tensile test of the film (a test piece: 150 mm in length×15 mm in width×9 to 50 jam in thickness, a stress rate: 100 mm/min). The test pieces are cut in each of the three directions.

### (Metal Foil)

A metal foil plays a role of a barrier to water vapor and the like, and pure aluminum or an O material (soft material) of an aluminum-iron alloy is generally used and preferred as the material of the metal foil. The thickness of aluminum foil is preferably about 10 to 100 μm for securing processability and for securing barrier properties of preventing permeation of oxygen and moisture into packaging. If the thickness of aluminum foil is less than 10 μm, the aluminum foil may break during forming or a pinhole may occur, causing permeation of oxygen and moisture. On the other hand, if the thickness of aluminum foil exceeds 100 μm, the improvement effect of breakage during forming and the effect of preventing occurrence of pinhole will not be particularly improved, but only the total thickness of a packaging material will be high, thus increasing mass and reducing volume energy density. Aluminum foil having a thickness of about 30 to 50 μm is generally used, and it is preferred to use aluminum foil having a thickness of 40 to 50 μm. Note that aluminum foil is preferably subjected to chemical conversion treatment, such as undercoat treatment with a silane coupling agent, a titanium coupling agent, and the like and chromate treatment, for improving adhesive properties with a resin film and improving corrosion resistance.

### (Resin Film)

As a resin film, a heat-fusible resin film made of polypropylene, polyethylene, maleic acid-modified polypropylene, an ethylene-acrylate copolymer, an ionomer resin, or the like is preferred. These resins have heat-sealing properties and function for improving the chemical resistance to a highly corrosive electrolytic solution of a lithium secondary battery and the like. The thickness of these films is preferably 9 to 100 μm, more preferably 20 to 80 μm, and most preferably 40 to 80 μm. When the thickness of a resin film is 9 μm or more, sufficient heat sealing strength will be obtained, and the corrosion resistance to an electrolytic solution and the like will be satisfactory. When the thickness of a resin film is 100 μm or less, a packaging material for a battery casing will have a sufficient strength and good formability.

### (Coating Layer)

The packaging material for a battery casing according to the embodiment of the present invention may be provided with a coating layer on an outer layer. Examples of the method of forming a coating layer include a method involving coating the outer layer with a polymer having gas barrier properties and a method involving vapor-depositing aluminum metal or an inorganic oxide such as silicon oxide and aluminum oxide to coat the outer layer with a thin film of the metal or the inorganic substance. A laminate having better barrier properties against water vapor and other gases can be obtained by providing a coating layer.

### [Battery Case]

The battery case according to the embodiment of the present invention is formed by using the packaging material for a battery casing according to the embodiment of the present invention. For example, it is formed of the packaging material for a battery casing. The packaging material for a battery casing according to the embodiment of the present invention is excellent in electrolytic solution resistance, heat resistance, and barrier properties against water vapor and other gases, and is suitably used as a battery case for a secondary battery, particularly for a lithium ion battery. Further, since the packaging material for a battery casing according to the embodiment of the present invention has very good formability, the battery case according to the embodiment of the present invention can be simply obtained by forming according to a known method. The method of forming is not particularly limited, but when the packaging material is formed by deep drawing or stretch forming, a battery case having a highly complicated shape and a high dimensional accuracy can be produced.

### EXAMPLES

Hereinafter, the present invention will be more specifically described with reference to Examples and Comparative Examples, but the present invention is not limited to these Examples at all.

### Synthesis Example 1

To a reaction vessel equipped with a stirrer and a water separator, were charged 220.00 g of “Sovermol 908” (manufactured by BASF AG) as a hydrogenated dimer diol, 230.00 g of “EMPOL 1008” (manufactured by BASF AG) as a hydrogenated dimer acid, and 0.10 g of dibutyltin dilaurate “KS-1260” (manufactured by Sakai Chemical Industry Co., Ltd.) as a catalyst. The mixture was subjected to dehydration esterification reaction at about 240° C. The pressure at the start of the reaction was normal pressure, and the pressure was then reduced while allowing condensed water to flow out, thus obtaining polyester polyol (hereinafter described as polyester polyol (1)).

### Synthesis Example 2

To a reaction vessel equipped with a stirrer, a thermometer and a condenser, were charged 108.00 g of “GI-1000” (a hydrogenated polybutadiene polyol, manufactured by Nippon Soda Co., Ltd.) as a component (a11), 12.00 g of “TCD Alcohol DM” (tricyclodecanedimethanol, manufactured by OXEA GmbH) as a component (a2), 0.04 g of hydroquinone monomethyl ether (manufactured by Wako Pure Chemical Industries, Ltd.) as an antioxidant, 0.03 g of “KS-1260” (dibutyltin dilaurate, manufactured by Sakai Chemical Industry Co., Ltd.) as a catalyst, 30.00 g of “Desmodur W” (methylene bis(4-cyclohexylisocyanate)), manufactured by Bayer AG) as a component (a3) and 70.00 g of toluene as a solvent (D). The mixture was heated to 85 to 90° C. using an oil bath with stirring. Then, the reaction was continued for 2.5 hours with stirring. Then, an infrared absorption spectrum was measured, and the reaction was completed when it was verified that absorption of an isocyanato group had disappeared. Further, thereto was added 80.00 g of toluene followed by stirring to dissolve the reaction product, thus obtaining a solution of polyurethane polyol (hereinafter described as polyurethane polyol (1)) in toluene (solid concentration: 50% by mass). The composition of the materials used in the Synthesis Example 2 is shown in Table 1.

### Synthesis Examples 3 to 7

The synthesis was performed in the same manner as Synthesis Example 2 except that the components shown in Table 1 were used, to obtain solutions of polyurethane polyols (2) to (6) in toluene (solid concentration: 50% by mass). In Table 1, G-1000 represents a polybutadiene polyol, manufactured by Nippon Soda Co., Ltd, and HS2B-5500 represents a polyester polyol (castor oil), manufactured by Hokoku Corporation.

In Synthesis Examples 2 to 7, the number of hydroxy groups contained in each of the components (a11), (a12) and (a2) was measured according to the method A of JIS K 1557-1: 2007 (titration method), and the number of isocyanato groups contained in the polyisocyanate (a3) was measured according to JIS K 6806: 2003 (titration method). Based on these measurement values, the ratio of the number of isocyanato groups contained in the polyisocyanate (a3) to the numbers of hydroxy groups contained in the components (a11), (a12) and (a2) (“NCO/OH ratio”) was calculated. The results are shown in Table 1.

### Example 1

To 60.00 g of the solution of the polyurethane polyol (1) in toluene (solid content: 30.00 g; toluene: 30.00 g) obtained in Synthesis Example 2 as a component (A), were added 3.20 g of “Duranate TKA-100” (an isocyanurate form of hexamethylene diisocyanate, manufactured by Asahi Kasei Chemicals Corporation) as a component (b1), 7.30 g of “Desmodur XP2565” (a mixture of an allophanatized multimer of isophorone diisocyanate (80 parts by mass) and butyl acetate (20 parts by mass), manufactured by Bayer AG) as a component (b2), 0.06 g of “BiCAT Z” (zinc neodecanoate, manufactured by Shepherd Chemical Company) as a component (C), and 99.44 g of toluene as a solvent (D) to prepare an adhesive for laminating a metal foil to a resin film 1 (composition 1).

The number of hydroxy groups contained in the polyurethane polyol (1) as the component (A) was measured according to the method A of JIS K 1557-1: 2007 (titration method). The number of isocyanato groups contained in each of Duranate TKA-100 as the component (b1) and Desmodur XP2565 as the component (b2) was measured according to JIS K 6806: 2003 (titration method). Based on these measurement values, the ratio of the number of isocyanato groups contained in the multimer of a saturated aliphatic polyisocyanate (b1) and the multimer of a saturated alicyclic polyisocyanate (b2) to the number of hydroxy groups contained in the polyol (A) was calculated. The results are shown in Table 2.

Next, a packaging material for a battery casing having a structure of outer layer/adhesive for outer layer/aluminum foil layer/laminating adhesive 1/resin film was produced by a dry lamination method using the laminating adhesive 1. Details of each layer are as follows.

Outer layer: Stretched polyamide film (25 μm in thickness)

Adhesive for outer layer: Urethane adhesive for dry lamination (AD502/CAT10: manufactured by Toyo-Morton, Ltd., coating amount: 3 g/m² (in coating))

Aluminum foil layer: Aluminum foil of aluminum-iron alloy (AA standard 8079-O material, thickness: 40 μm)

Laminating adhesive 1: The adhesive 1 for laminating (coating amount: thickness after drying being 2 μm)

Resin film: Non-stretched polypropylene film (thickness: 40 μm)

### Examples 2-14, Comparative Examples 1-9

The adhesives 2 to 23 for laminating a metal foil to a resin film (compositions 2 to 23) were prepared in the same manner as Example 1 except that the components shown in Tables 2 to 4 were used.

Then, a packaging material for a battery casing was produced in the same manner as Example 1 except that each of adhesives 2 to 23 for laminating was used instead of the adhesive 1 for laminating.

The details of each component in Tables 2 to 4 are as follows:
Acid-modified polypropylene: an acid-modified polypropylene (acid value: 20 mg/KOH) modified with maleic anhydride and octyl acrylate;
Duranate TKA-100: an isocyanurate form of hexamethylene diisocyanate, manufactured by Asahi Kasei Chemicals Corporation;
Hexamethylene diisocyanate: a reagent manufactured by Tokyo Chemical Industry Co., Ltd.;
Desmodur XP2565: a mixture of an allophanatized multimer of isophorone diisocyanate (80 parts by mass) and butyl acetate (20 parts by mass), manufactured by Bayer AG;
Desmodur Z4470: a mixture of an isocyanurate form of isophorone diisocyanate (70 parts by mass) and butyl acetate (30 parts by mass), manufactured by Bayer AG;
Isophorone diisocyanate: a reagent manufactured by Tokyo Chemical Industry Co., Ltd.;
BiCAT Z: zinc neodecanoate, manufactured by Shepherd Chemical Company;
Hexoate zinc: a mixture of zinc 2-ethylhexanoate (65 parts by mass) and mineral spirits (35 parts by mass), manufactured by TOEI CHEMICAL INDUSTRY CO., LTD.;
Afco Chem ZNS-P: zinc stearate, manufactured by ADEKA CORPORATION;
Zinc acetylacetonate: a reagent manufactured by Tokyo Chemical Industry Co., Ltd.;
Hexoate manganese: a mixture of manganese octylate (42 parts by mass) and mineral spirits (58 parts by mass), manufactured by TOEI CHEMICAL INDUSTRY CO., LTD.;
KS-1260: dibutyltin dilaurate, manufactured by Sakai Chemical Industry Co., Ltd.;
Titanium acetylacetonate: a reagent manufactured by Tokyo Chemical Industry Co., Ltd.; and
BiCAT 8210: a mixture of bismuth tris(2-ethylhexanoate) (89 parts by mass) and 2-ethylhexanoic acid (11 parts by mass), manufactured by Shepherd Chemical Company.

### <Peel Strength>

A test piece having 150 mm in length×15 mm in width which was cut from each of the resulting packaging materials for a battery casing was used to measure T-peel strength after immersing in an electrolytic solution solvent, T-peel strength after immersing in an electrolytic solution solvent for a long period and T-peel strength in 85° C. atmosphere. The conditions and methods of measurement are as described in the following (1) to (3). Each test was performed by n=2 (measurements for 2 test pieces), and the average value was taken. Further, the results are shown in Tables 2 to 4 (the unit is all N/15 mm).

(1) T-Peel Strength after Immersing in Electrolytic Solution Solvent

A test piece having 150 mm in length×15 mm in width was immersed in an electrolytic solution solvent (ethylene carbonate/diethyl carbonate, mass ratio: 50/50) at 85° C. for one day and taken out of the solvent. Then, the test piece was measured with Autograph AG-X (manufactured by Shimadzu Corporation) for the 180° peel strength between an aluminum foil layer and a non-stretched polypropylene film layer at a peel rate of 100 mm/min in an atmosphere of 23° C.×50% RH. The results are shown in Tables 2 to 4.

(2) T-Peel Strength after Immersing in an Electrolytic Solution Solvent for a Long Period

The 180° peel strength between an aluminum foil layer and a non-stretched polypropylene film layer was measured in the same manner as (1), except that the period of immersion in the electrolytic solution solvent at 85° C. was changed from 1 day to 4 weeks. The results are shown in Tables 2 to 4.

### (3) T-Peel Strength in 85° C. Atmosphere

A test piece having 150 mm in length×15 mm in width and Autograph AG-X (manufactured by Shimadzu Corporation) were used. The test piece was allowed to stand in 85° C. atmosphere to allow the temperature of the test piece to reach 85° C. and then peeled at a peel rate of 100 mm/min to measure the 180° peel strength between an aluminum foil layer and a non-stretched polypropylene film layer. The results are shown in Tables 2 to 4.

TABLE 1

| | | Synthesis | Synthesis | Synthesis | Synthesis | Synthesis | Synthesis |
|---|---|---|---|---|---|---|---|
| | | Example 2 | Example 3 | Example 4 | Example 5 | Example 6 | Example 7 |
| | | Polyurethane | Polyurethane | Polyurethane | Polyurethane | Polyurethane | Polyurethane |
| Composition (unit: g) | | polyol (1) | polyol (2) | polyol (3) | polyol (4) | polyol (5) | polyol (6) |
| Component | GI-1000 | 108.00 | 120.00 | | | | |
| (a11): Chain | (Hydrogenated | | | | | | |
| polyolefin | polybutadiene polyol) | | | | | | |
| polyol | G-1000 | | | 108.00 | | | |
| | (Polybutadiene polyol) | | | | | | |
| Component | Polyester polyol (1) | | | | 108.00 | 120.00 | |
| (a12): | HS 2B-5500 | | | | | | 108.00 |
| Polyester | (Castor oil) | | | | | | |
| polyol | | | | | | | |
| Component | TCD Alcohol DM | 12.00 | | 12.00 | 12.00 | | 12.00 |
| (a2): | (tricyclodecane | | | | | | |
| Alicyclic | dimethanol) | | | | | | |
| polyol | | | | | | | |
| Component | Desmodur | 30.00 | 17.40 | 30.00 | 27.90 | 15.00 | 55.00 |
| (a3): | W(methylene bis(4- | | | | | | |
| Polyisocyanate | cyclohexylisocyanate)) | | | | | | |
| Catalyst | KS-1260 | 0.03 | 0.03 | 0.03 | 0.03 | 0.03 | 0.03 |
| | (dibutyltin dilaurate) | | | | | | |
| Antioxidant | Hydroquinone | 0.04 | 0.04 | 0.04 | 0.04 | 0.04 | 0.04 |
| | monomethyl ether | | | | | | |
| Solvent | Toluene | 150.00 | 137.40 | 150.00 | 147.90 | 135.00 | 175.00 |
| NCO/OH | | 0.9 | 0.9 | 0.9 | 0.9 | 0.9 | 0.9 |
| ratio | | | | | | | |

TABLE 2

| Composition | Example | 1 | 2 | 3 | 4 | 5 | 6 |
|---|---|---|---|---|---|---|---|
| (unit: g)*2 | Composition | 1 | 2 | 3 | 4 | 5 | 6 |
| Component (A): | (1) | 60.00 | 60.00 | 60.00 | 60.00 | 60.00 | 60.00 |
| Polyurethane | (2) | | | | | | |
| polyol | (3) | | | | | | |
| | (4) | | | | | | |
| | (5) | | | | | | |
| | (6) | | | | | | |
| Modified | Acid-modified | | | | | | |
| polyolefin | polypropylene | | | | | | |
| Component (b1) | Duranate TKA-100 | 3.20 | 3.20 | 3.20 | 3.20 | 3.20 | 3.20 |
| | (isocyanurate form of | | | | | | |
| | hexamethylene | | | | | | |
| | diisocyanate) | | | | | | |
| Saturated | Hexamethylene | | | | | | |
| aliphatic | diisocyanate | | | | | | |
| diisocyanate | | | | | | | |
| Component (b2) | Desmodur XP2565 | 7.30 | | 7.30 | 7.30 | 7.30 | 7.30 |
| | (allophanatized multimer | | | | | | |
| | of isophorone | | | | | | |
| | diisocyanate) | | | | | | |
| | Desmodur Z4470 | | 8.50 | | | | |
| | (isocyanurate form of | | | | | | |
| | isophorone diisocyanate) | | | | | | |
| Saturated | Isophorone diisocyanate | | | | | | |
| alicyclic | | | | | | | |
| diisocyanate | | | | | | | |
| Component (C) | BiCAT Z | 0.06 | 0.06 | | | | |
| | (zinc neodecanoate) | | | | | | |
| | Hexoate zinc | | | 0.10 | | | |
| | Afco Chem ZNS-P | | | | 0.15 | | |
| | (zinc stearate) | | | | | | |
| | Zinc acetylacetonate | | | | | 0.09 | |
| | Hexoate manganese | | | | | | 0.25 |
| Metal Catalyst | KS-1260 | | | | | | |
| | (dibutyltin dilaurate) | | | | | | |
| | Titanium acetylacetonate | | | | | | |
| | BiCAT8210 | | | | | | |
| | (bismuth tris(2-ethylhexanoate)) | | | | | | |
| Component (D): | Toluene | 99.44 | 98.72 | 99.57 | 99.74 | 99.54 | 99.42 |
| Solvent | | | | | | | |

| | | | | | | |
|---|---|---|---|---|---|---|
| NCO/OH ratio*1 | 6.0 | 6.0 | 6.0 | 6.0 | 6.0 | 6.0 |
| (b1)/{(b1) + (b2)}(mass ratio) | 0.35 | 0.35 | 0.35 | 0.35 | 0.35 | 0.35 |
| Amount of component (C) (parts by mass) vs. 100 | 0.032 | 0.032 | 0.040 | 0.052 | 0.074 | 0.056 |
| parts by mass of Component (A) | | | | | | |
| (in terms of mass of metal) | | | | | | |
| (D)/{A + B + C + D} (% by mass) | 76.8 | 76.8 | 76.7 | 76.8 | 76.8 | 76.8 |
| T-peel strength after immersing in | 12.4 | 11.8 | 11.5 | 11.5 | 10.8 | 10.5 |
| electrolytic solution solvent (N/15 mm) | | | | | | |
| T-peel strength after immersing in | 11.0 | 10.8 | 9.6 | 9.5 | 8.2 | 8.0 |
| electrolytic solution solvent for long period | | | | | | |
| (N/15 mm) | | | | | | |
| T-peel strength in 85° C. atmosphere | 6.5 | 6.5 | 5.8 | 5.1 | 5.3 | 6.3 |
| (N/15 mm) | | | | | | |

*1The ratio of the number of isocyanato groups contained in the multimer of a saturated aliphatic polyisocyanate (b1) and the multimer of a saturated alicyclic polyisocyanate (b2) to the number of hydroxy groups contained in the polyol (A).
*2The numerical value is “as-is” basis.

TABLE 3

| Composition | Example | 7 | 8 | 9 | 10 | 11 | 12 | 13 | 14 |
|---|---|---|---|---|---|---|---|---|---|
| (unit: g)*2 | Composition | 7 | 8 | 9 | 10 | 11 | 12 | 13 | 14 |
| Component (A): | (1) | | | | | 60.00 | 60.00 | 60.00 | |
| Polyurethane | (2) | 60.00 | | | | | | | |
| polyol | (3) | | 60.00 | | | | | | |
| | (4) | | | 60.00 | | | | | |
| | (5) | | | | 60.00 | | | | |
| | (6) | | | | | 60.00 | | | |
| Modified | Acid-modified | | | | | | | | |
| polyolefin | polypropylene | | | | | | | | |
| Component (b1) | Duranate TKA-100 | 3.20 | 3.20 | 3.20 | 3.20 | 3.20 | 3.20 | 3.20 | 3.20 |
| | (isocyanurate form of | | | | | | | | |
| | hexamethylene | | | | | | | | |
| | diisocyanate) | | | | | | | | |
| Saturated | Hexamethylene | | | | | | | | |
| aliphatic | diisocyanate | | | | | | | | |
| diisocyanate | | | | | | | | | |
| Component (b2) | Desmodur XP2565 | 7.30 | 7.30 | | | | 7.30 | 7.30 | 7.30 |
| | (allophanatized multimer | | | | | | | | |
| | of isophorone | | | | | | | | |
| | diisocyanate) | | | | | | | | |
| | Desmodur Z4470 | | | 8.50 | 8.50 | 8.50 | | | |
| | (isocyanurate form of | | | | | | | | |
| | isophorone diisocyanate) | | | | | | | | |
| Saturated | Isophorone diisocyanate | | | | | | | | |
| alicyclic | | | | | | | | | |
| diisocyanate | | | | | | | | | |
| Component (C) | BiCAT Z | 0.06 | 0.06 | 0.06 | 0.06 | 0.06 | 1.50 | 4.86 | 7.26 |
| | (zinc neodecanoate) | | | | | | | | |
| | Hexoate zinc | | | | | | | | |
| | Afco Chem ZNS-P | | | | | | | | |
| | (zinc stearate) | | | | | | | | |
| | Zinc acetylacetonate | | | | | | | | |
| | Hexoate manganese | | | | | | | | |
| Metal Catalyst | KS-1260 | | | | | | | | |
| | (dibutyltin dilaurate) | | | | | | | | |
| | Titanium acetylacetonate | | | | | | | | |
| | BiCAT8210 | | | | | | | | |
| | (bismuth tris(2-ethylhexanoate)) | | | | | | | | |
| Component (D): | Toluene | 99.44 | 99.44 | 98.72 | 98.72 | 98.72 | 104.26 | 115.51 | 123.54 |
| Solvent | | | | | | | | | |

| | | | | | | | | |
|---|---|---|---|---|---|---|---|---|
| NCO/OH ratio*1 | 6.0 | 6.0 | 6.0 | 6.0 | 6.0 | 6.0 | 6.0 | 6.0 |
| (b1)/{(b1) + (b2)1(mass ratio) | 0.35 | 0.35 | 0.35 | 0.35 | 0.35 | 0.35 | 0.35 | 0.35 |
| Amount of component (C) (parts by mass) vs. 100 | 0.032 | 0.032 | 0.032 | 0.032 | 0.032 | 0.801 | 2.597 | 3.879 |
| parts by mass of Component (A) | | | | | | | | |
| (in terms of mass of metal) | | | | | | | | |
| (D)/{A + B + C + D} (% by mass) | 76.8 | 76.8 | 76.7 | 76.7 | 76.7 | 76.8 | 76.8 | 76.8 |
| T-peel strength after immersing in | 9.5 | 10.0 | 11.5 | 9.0 | 9.8 | 13.5 | 13.4 | 12.0 |
| electrolytic solution solvent (N/15 mm) | | | | | | | | |
| T-peel strength after immersing in | 7.8 | 9.0 | 8.4 | 7.5 | 8.0 | 12.2 | 12.2 | 10.5 |
| electrolytic solution solvent for long period | | | | | | | | |
| (N/15 mm) | | | | | | | | |
| T-peel strength in 85° C. atmosphere | 4.5 | 6.0 | 7.1 | 6.6 | 6.2 | 8.0 | 8.1 | 6.8 |
| (N/15 mm) | | | | | | | | |

*1The ratio of the number of isocyanato groups contained in the multimer of a saturated aliphatic polyisocyanate (b1) and the multimer of a saturated alicyclic polyisocyanate (b2) to the number of hydroxy groups contained in the polyol (A).
*2The numerical value is “as-is” basis.

TABLE 4

| Composition | Comparative Example | 1 | 2 | 3 | 4 | 5 | 6 | 7 | 8 | 9 |
|---|---|---|---|---|---|---|---|---|---|---|
| (unit: g)*2 | Composition | 15 | 16 | 17 | 18 | 19 | 20 | 21 | 22 | 23 |
| Component (A): | (1) | 60.00 | | 60.00 | 60.00 | 60.00 | 60.00 | 60.00 | 60.00 | |
| Polyurethane | (2) | | | | | | | | | |
| polyol | (3) | | | | | | | | | |
| | (4) | | 60.00 | | | | | | | |
| | (5) | | | | | | | | | |
| | (6) | | | | | | | | | |
| Modified | Acid-modified | | | | | | | | | |
| polyolefin | polypropylene | | | | | | | | | 30.00 |
| Component (b1) | Duranate TKA-100 | 3.20 | 3.20 | 3.20 | | | 3.20 | 3.20 | 3.20 | 6.00 |
| | (isocyanurate form of | | | | | | | | | |
| | hexamethylene | | | | | | | | | |
| | diisocyanate) | | | | | | | | | |
| Saturated | Hexamethylene | | | | | 1.40 | | | | |
| aliphatic | diisocyanate | | | | | | | | | |
| diisocyanate | | | | | | | | | | |
| Component (b2) | Desmodur XP2565 | 7.30 | 7.30 | | 7.30 | | 7.30 | 7.30 | 7.30 | |
| | (allophanatized multimer | | | | | | | | | |
| | of isophorone | | | | | | | | | |
| | diisocyanate) | | | | | | | | | |
| | Desmodur Z4470 | | | | | | | | | |
| | (isocyanurate form of | | | | | | | | | |
| | isophorone diisocyanate) | | | | | | | | | |
| Saturated | Isophorone diisocyanate | | | | | 1.87 | | | | |
| alicyclic | | | | | | | | | | |
| diisocyanate | | | | | | | | | | |
| Component (C) | BiCAT Z | | | 0.06 | 0.06 | 0.06 | | | | |
| | (zinc neodecanoate) | | | | | | | | | |
| | Hexoate zinc | | | | | | | | | |
| | Afco Chem ZNS-P | | | | | | | | | |
| | (zinc stearate) | | | | | | | | | |
| | Zinc acetylacetonate | | | | | | | | | |
| | Hexoate manganese | | | | | | | | | |
| Metal Catalyst | KS-1260 | | | | | | 0.12 | | | |
| | (dibutyltin dilaurate) | | | | | | | | | |
| | Titanium acetylacetonate | | | | | | | 0.14 | | |
| | BiCAT8210 | | | | | | | | 0.11 | |
| | (bismuth tris(2-ethylhexanoate)) | | | | | | | | | |
| Component (D): | Toluene | 99.24 | 99.24 | 81.35 | 88.73 | 81.58 | 99.64 | 99.71 | 99.61 | 240.00 |
| Solvent | | | | | | | | | | |

| | | | | | | | | | |
|---|---|---|---|---|---|---|---|---|---|
| NCO/OH ratio*1 | 6.0 | 6.0 | 3.0 | 3.0 | 6.0 | 6.0 | 6.0 | 6.0 | — |
| (b1)/{(b1) + (b2)}(mass ratio) | 0.35 | 0.35 | 1.00 | 0.00 | — | 0.35 | 0.35 | 0.35 | 1.00 |
| Amount of component (C) (parts by mass) vs. 100 | 0.000 | 0.000 | 0.032 | 0.032 | 0.032 | 0.000 | 0.000 | 0.000 | 0.000 |
| parts by mass of Component (A) | | | | | | | | | |
| (in terms of mass of metal) | | | | | | | | | |
| (D)/{A + B + C + D}(% by mass) | 76.8 | 76.8 | 77.0 | 76.8 | 77.0 | 76.9 | 76.9 | 76.9 | 88.2 |
| T-peel strength after immersing in | 12.0 | 11.6 | 8.2 | 5.1 | 5.0 | 11.1 | 11.6 | 11.7 | 12.0 |
| electrolytic solution solvent (N/15 mm) | | | | | | | | | |
| T-peel strength after immersing in | 6.0 | 5.4 | 5.0 | 2.5 | 1.8 | 5.9 | 5.5 | 5.3 | 9.0 |
| electrolytic solution solvent for long period | | | | | | | | | |
| (N/15 mm) | | | | | | | | | |
| T-peel strength in 85° C. atmosphere | 4.4 | 5.6 | 4.8 | 2.5 | 2.0 | 4.5 | 4.5 | 4.6 | 1.9 |
| (N/15 mm) | | | | | | | | | |

*1The ratio of the number of isocyanato groups contained in the multimer of a saturated aliphatic polyisocyanate (b1) and the multimer of a saturated alicyclic polyisocyanate (b2) to the number of hydroxy groups contained in the polyol (A).
*2The numerical value is “as-is” basis.

### DISCUSSION

The results in Tables 2 and 3 show that the adhesives for laminating a metal foil to a resin film of the present invention (Examples 1 to 14) are excellent, in a well-balanced manner, in all of the T-peel strength after immersing in an electrolytic solution solvent, the T-peel strength after immersing in an electrolytic solution solvent for a long period, and the T-peel strength in 85° C. atmosphere.

On the other hand, the results in Table 4 show that the adhesives for laminating a metal foil to a resin film which do not contain the component (C) (Comparative Examples 1 and 2) are insufficient in the T-peel strength after immersing in an electrolytic solution solvent for a long period; the adhesives for laminating a metal foil to a resin film which do not contain the components (b1) and/or (b2) (Comparative Examples 3 to 5) are insufficient in the T-peel strength after immersing in an electrolytic solution solvent and the T-peel strength after immersing in an electrolytic solution solvent for a long period; the adhesives in which the component (C) is changed to a compound of a metal other than Groups 7 and/or 12 (Comparative Examples 6 to 8) are insufficient in the T-peel strength after immersing in an electrolytic solution solvent for a long period; and the adhesive for laminating a metal foil to a resin film in which a modified polyolefin is used as a base resin (Comparative Example 9) is insufficient in the T-peel strength in 85° C. atmosphere.

### INDUSTRIAL APPLICABILITY

The adhesive for laminating a metal foil to a resin film of the present invention has an excellent adhesive strength after long-term immersing in an electrolytic solution and at high temperatures, and is particularly suitable for joining aluminum foil to a heat-fusible resin film. Further, since the laminate of the present invention is excellent in heat resistance and electrolytic solution resistance, it is suitably used for a packaging material for a battery casing used in the preparation of secondary batteries such as lithium ion batteries; and the laminate can be formed to thereby produce a battery case excellent in heat resistance and electrolytic solution resistance. Thus, the production of a safe secondary battery having a long life is achieved by using the battery case.

1. An adhesive for laminating a metal foil to a resin film, the adhesive comprising: a polyol (A); a multimer of a polyisocyanate (B); and a metal compound (C) being a compound of at least one metal of Groups 7 and 12,
wherein the multimer of a polyisocyanate (B) comprises a multimer of a saturated aliphatic polyisocyanate (b1) and a multimer of a saturated alicyclic polyisocyanate (b2).

2. The adhesive for laminating a metal foil to a resin film according to claim 1, wherein the polyol (A) comprises a polyurethane polyol obtained by polyaddition of components comprising at least one of a chain polyolefin polyol (a11) and a polyester polyol (a12), a hydroxylated cyclic hydrocarbon compound (a2) having both a saturated cyclic hydrocarbon structure and two or more hydroxy groups, and a polyisocyanate (a3).

3. The adhesive for laminating a metal foil to a resin film according to claim 2, wherein the polyester polyol (a12) comprises a polyester polyol having a constituent unit derived from a hydrogenated dimer acid and a constituent unit derived from a hydrogenated dimer diol.

4. The adhesive for laminating a metal foil to a resin film according to claim 1, wherein the multimer of a saturated aliphatic polyisocyanate (b1) comprises an isocyanurate form of a saturated aliphatic polyisocyanate.

5. The adhesive for laminating a metal foil to a resin film according to claim 1, wherein the multimer of a saturated alicyclic polyisocyanate (b2) comprises a multimer of isophorone diisocyanate.

6. The adhesive for laminating a metal foil to a resin film according to claim 1, wherein the ratio of the number of isocyanato groups contained in the multimer of a saturated aliphatic polyisocyanate (b1) and the multimer of a saturated alicyclic polyisocyanate (b2) to the number of hydroxy groups contained in the polyol (A) is 1 to 15.

7. The adhesive for laminating a metal foil to a resin film according to claim 1, wherein the metal compound (C) comprises at least one or more carboxylate of at least one metal of Groups 7 and 12.

8. The adhesive for laminating a metal foil to a resin film according to claim 1, wherein the metal compound (C) comprises a carboxylate of zinc or manganese.

9. The adhesive for laminating a metal foil to a resin film according to claim 1, the adhesive further comprising a solvent (D).

10. A laminate in which a metal foil and a resin film are laminated through an adhesive layer obtained from the adhesive for laminating a metal foil to a resin film according to claim 1.

11. The laminate according to claim 10, wherein the metal foil is aluminum foil, and the resin film comprises a heat-fusible resin film.

12. The laminate according to claim 10, wherein the thickness of the metal foil is 10 to 100 μm, and the thickness of the resin film is 9 to 100 μm.

13. A packaging material for a battery casing obtained by using the laminate according to claim 10.

14. A battery case obtained by using the packaging material for a battery casing according to claim 13.

15. A method for producing a battery case, comprising: deep drawing or stretch forming the packaging material for a battery casing according to claim 13.
